(19) United States
(12) Patent Application Publication
(10) Pub. No.: US 2005/0078128 A1
(43) Pub. Date: Apr. 14, 2005

(54) Display control

(75) Inventor: Norhito Ozeki, Yamato-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/964,194

(22) Filed: Oct. 13, 2004

(30) Foreign Application Priority Data
Oct. 14, 2003 (JP) 2003-353190

(51) Int. Cl. G09G 3/32; G09G 5/10

(52) U.S. Cl. 345/690

(57) ABSTRACT

A maximum brightness limiting mechanism limits the maximum brightness of the display to a brightness selected by a brightness selecting mechanism. If a user operates the brightness-increasing operating member a number of times in a unit time equal to or larger than a predetermined number of times when the brightness of the display is a second brightness, a particular operation detecting mechanism detects this operation as a particular operation. Upon this detection, the brightness selecting mechanism changes the selected brightness from the second brightness to a first brightness.

### BACKGROUND OF THE INVENTION

The present invention relates to a controller, a control method, and a control program product for a display device provided in a portable PC (personal computer) for example and, more particularly, to a display controller, a display control method, and a display control program product for suitably controlling the maximum brightness of a display.

Notebook PCs can operate by power supplied from either of an external alternating-current power supply and an incorporated chargeable battery. The amount of power consumed by an LCD (liquid crystal display) provided in a notebook PC is large. In a typical notebook PC, therefore, the LCD is operated at a suitable low brightness when battery power is used, while it is operated at a high brightness when power from an external alternating-current power supply is used. The battery operating time is thereby increased.

In the conventional notebook PCs, the brightness of the LCD is automatically fixed at a reduced brightness level when battery power is used. In contrast, in a notebook PC in patent document 1, a user calls up a predetermined operator setting view on the screen of the PC and inputs to a predetermined input section a value for the brightness level according to his/her preference to increase the brightness of the LCD relative to the brightness automatically set during use of a battery.

In a notebook PC put on the market by the Applicant of the present invention, a keyboard is provided with two brightness adjustment keys for increasing and reducing by step the brightness of the display, and selection is made between an ordinary high-brightness table and a low-brightness table for energy saving when power from an external alternating-current power supply or power from a battery is used. On the basis of the selected brightness table, the brightness of the display is increased or reduced one step when the brightness adjustment may is operated one time. In this notebook PC, the switch is automatically made between the high-brightness table and the low-brightness table with the switch between the battery and the external alternating-current power supply. Also, even during use of battery power, a user can switch to the high-brightness table, for example, by starting a predetermined user setting application, reaching a menu at a lower hierarchical level through a menu in a hierarchical structure in this application and selecting a predetermined command in the lower-hierarchical-level menu.

Patent Document 1

Published Unexamined Patent Application No. 7-141075

Problems to Be Solved by the Invention

Switching operations in conventional maximum brightness changing operations are complicated and require a long operation time since they are a process in which a user starts a brightness changing application and inputs a value for the brightness level according to his/her preference, and a menu at a low hierarchical level is displayed, and the like. On the other hand, addition of an operating member for changing the maximum brightness, for example, to a keyboard of a notebook PC is not preferable because of restrictions in terms of space and cost.

### SUMMARY OF THE INVENTION

Accordingly, a purpose of the present invention is to provide a display controller designed so that the maximum brightness of a display can be changed with efficiency while addition of any new operating member for an operation to change the maximum brightness of the display is avoided, a display control method, and a display control program product for the display controller.

A display controller in accordance with the present invention is applied to a predetermined display device which has a brightness-increasing operating member which is operated one time in a predetermined manner by a user in order to increase the brightness of the display one step. The brightness-increasing operating member may be located on the display device or a body of a PC such as a portable PC. There is no restriction about the location of the brightness-increasing operating member. The display controller in accordance with the present invention comprises:
brightness increasing means for increasing the brightness of the display on the basis of an operation on the brightness-increasing operating member;
brightness selecting means for selecting as a selected brightness a first brightness or a second brightness lower that the first brightness;
maximum brightness limiting means for limiting the maximum brightness of the display to the brightness selected by the brightness selecting means;
particular operation detecting means for detecting a particular operation in operations on the brightness-increasing operating member in the predetermined manner by regarding the particular operation as a user's request for increasing the maximum brightness; and
changing means for making the brightness selecting means change the selected brightness from the second brightness to the first brightness if the particular operation is detected when the brightness selected by the brightness selecting means is the second brightness.

Another display controller in accordance with the present invention is applied to a predetermined display device which has a brightness-changing operating member which is operated one time in a predetermined manner by a user in order to change the brightness of the display one step. The another display controller in accordance with the present invention comprises:
step determination means for determining the present step on the basis of the operation on the brightness-changing operating member;
table selecting means for selecting as a selected brightness table a first brightness table or a second brightness table, the brightness of the display being related to a finite number of steps in each brightness table in such a manner that the brightness increases in correspondence with the order from the lowest step to the highest step, the brightness related to the highest step in the first brightness table being higher than the brightness related to the highest step in the second brightness table;
brightness control means for controlling the brightness of the display so that the actual brightness of the display is set to the brightness related to the step determined by the step determination means in the brightness table selected by the table selecting means;
particular operation detecting means for detecting a particular operation in operations on the brightness-changing operating member in the predetermined manner when the brightness table selected by the table selecting means is the second brightness table, by regarding the particular operation as a user's request for increasing the maximum brightness; and
selection control means for making the table selecting means change the selected brightness table from the second brightness table to the first brightness table on the basis of detection of the particular operation.

A display control method in accordance with the present invention is applied to a predetermined display device which has a brightness-increasing operating member which is operated one time in a predetermined manner by a user in order to increase the brightness of the display one step. The display control method in accordance with the present invention comprises the following steps:
a step of increasing the brightness of the display on the basis of an operation on the brightness-increasing operating member;
a step of selecting as a selected brightness a first brightness or a second brightness lower that the first brightness;
a step of limiting, if the selected brightness is changed, the maximum brightness of the display on the basis of the changed selected brightness;
a step of detecting a particular operation in operations in operations on the brightness-increasing operating member in the predetermined manner by regarding the particular operation as a user's request for increasing the maximum brightness; and
a step of changing the selected brightness from the second brightness to the first brightness if the particular operation is detected when the selected brightness is the second brightness.

Another display control method in accordance with the present invention is applied to a predetermined display device which has a brightness-changing operating member which is operated one time in a predetermined manner by a user in order to change the brightness of the display one step. The another display control method in accordance with the present invention comprises the following steps:
a step determination step of determining the present step on the basis of the operation on the brightness-changing operating member;
a selecting step of selecting as a selected brightness table a first brightness table or a second brightness table, the brightness of the display being related to a finite number of steps in each brightness table in such a manner that the brightness increases in correspondence with the order from the lowest step to the highest step, the brightness related to the highest step in the first brightness table being higher than the brightness related to the highest step in the second brightness table;
a brightness control step of executing, on condition that the selected brightness table or the present step is changed, such control that the actual brightness of the display is set to the brightness related to the present step in the selected brightness table;
a particular operation detecting step of detecting a particular operation in operations on the brightness-changing operating member in the predetermined manner when the selected brightness table is the second brightness table, by regarding the particular operation as a user's request for increasing the maximum brightness; and
a selection control step of changing the selected brightness table from the second brightness table to the first brightness table on the basis of detection of the particular operation.

A display control program product in accordance with the present invention enables a computer to function as each means of the above-described display controllers or display controllers in embodiments described below, or enables a computer to function as each step in the above-described display control methods or display control methods in the embodiments described below.

According to the present invention, a particular operation in operations performed on the operating member in a predetermined manner by a user when the user increases the brightness of a display one step is regarded as a user's request for increasing the maximum brightness. When this operation is detected, the maximum brightness of the display is increased. The need for adding an operating member for changing the maximum brightness separately from the operating member for changing the brightness can be eliminated and the troublesome operation to be performed by the user to start a predetermined application can be omitted.

### BRIEF DESCRIPTION OF THE DRAWINGS

Some of the purposes of the invention having been stated, others will appear as the description proceeds, when taken in connection with the accompanying drawings, in which:

FIG. 1 is a perspective view of a notebook PC;

FIG. 2 is graph showing characteristic curves relating to control of the brightness of an LCD;

FIG. 3 is a functional block diagram of a display controller;

FIG. 4 is a functional block diagram of another display controller;

FIG. 5 is a flowchart of first partial processing according to a first display control method;

FIG. 6 is a flowchart of second partial processing according to the first display control method;

FIG. 7 is a flowchart of third partial processing according to the first display control method;

FIG. 8 is a flowchart of fourth partial processing according to the first display control method;

FIG. 9 is a flowchart of first partial processing according to a second display control method;

FIG. 10 is a flowchart of second partial processing according to the second display control method;

FIG. 11 is a flowchart of third partial processing according to the second display control method;

FIG. 12 is a flowchart of fourth partial processing according to the second display control method; and

FIG. 13 is a diagram of the configuration of hardware for executing a program.

### DETAILED DESCRIPTION OF THE ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

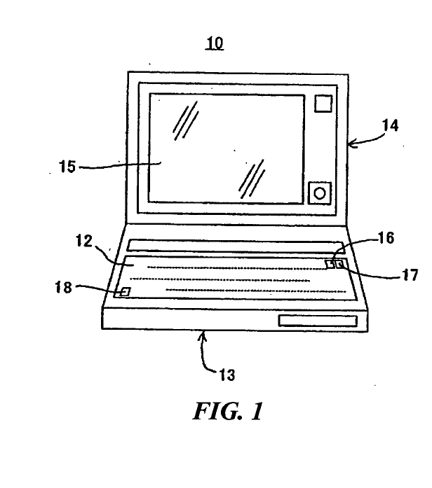

Referring now more particularly to the accompanying drawings, in which like numerals indicate like elements or steps throughout the several views, FIG. 1 is a perspective view of a notebook PC 10. The notebook PC 10 has a main body 13 having a keyboard 12 provided in its upper surface, and a lid 14 having its lower side portion rotatably connected to an inner side portion of the main body 13 so that the lid 14 on the main body 13 is openable and closable. An LCD 15 is provided on the side of the lid 14 where it faces the main body 13 when the lid 14 is at the closed position on the main body 13. The keyboard 12 has character and numeric input keys, function keys, etc., arranged in vertical and horizontal directions. A down key 16 and an up key 17 are provided in a right inner region of the keyboard 12 adjacent to each other in the left-right direction. A control key 18 is provided in a front left region of the keyboard 12. In this notebook PC 10, when a user depresses only one of the down key 16 and the up key 17, input or control different from adjustment of the brightness of the LCD 15 is performed. When the user depresses the control key 18 by a predetermined one of the left hand fingers and, while maintaining this state, depresses the down key 16 or the up key 17 by a predetermined one of the right hand fingers, the brightness of the LCD 15 is reduced or increased one step. If an additional space can be spared in the key layout of the keyboard 12, two special-purpose keys on each of which a single operation to increase or reduce the brightness of the LCD 15 one step can be performed without depressing the control key 18 may be provided. The notebook PC 10 has a chargeable internal battery not illustrated and is capable of selectively using power from an external alternating-current power supply and power from the internal battery. In the notebook PC 10, while the notebook PC 10 is using power from an external alternating-current power supply through which power is supplied from an electric power utility company (strictly speaking, a direct-current power at a predetermined voltage obtained through an adaptor converting alternating-current power from the external alternating-current power supply), the internal battery is charged with power from the external alternating-current power supply. When the notebook PC 10 is not connected to the external alternating-current power supply, power from the internal battery is used.

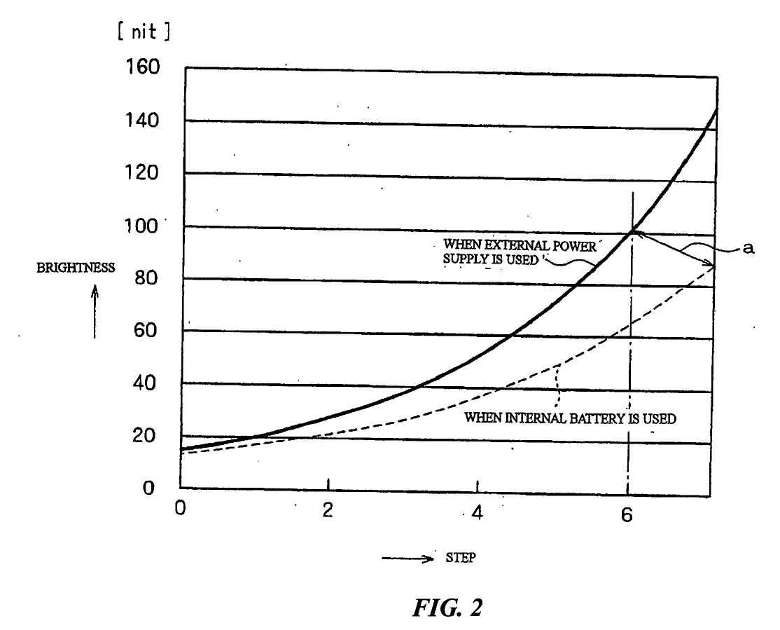

FIG. 2 is a graph showing characteristic curves relating to control of the brightness of the LCD 15. In FIG. 2, the abscissa represents steps and the ordinate represents the brightness (in nit). Steps from a lowest step 0 to a highest step 7 or a total of eight steps expressed by three bits exist. The solid-line characteristic curve (hereinafter referred to as “AC characteristic curve”) represents the relationship between the steps and the brightness of the LCD 15 during a time period when the notebook PC 10 uses power from the external alternating-current power supply. The broken-line characteristic curve (hereinafter referred to as “DC characteristic curve”) represents the relationship between the steps and the brightness of the LCD 15 during a time period when the notebook PC 10 uses power from the internal battery. If the brightness of the LCD 15 is increased, the amount of power consumed by the LCD 15 is increased. The AC characteristic curve and the DC characteristic curve designate the same brightness at step 0. In the range from step 1 to step 7, the AC characteristic curve is above the DC characteristic curve and the difference between the brightness according to the AC characteristic curve and the brightness according to the DC characteristic curve at each step is larger than that at the adjacent lower step. The brightness on the AC characteristic curve at step 0 may be set higher than that on the DC characteristic curve by a suitable value. In the notebook PC 10, a counter for determining which step is the present step is constituted by a piece of software or hardware, and the count value of this counter corresponds to the present step. The count value is decremented by one each time the user depresses the down key 16 while depressing the control key 18, and is incremented by one each time the user depresses the up key 17. The minimum and the maximum of the count value of the counter are 0 and 7, respectively. When the present step is step 0, the present step is maintained as step 0 even if the user further depresses the down key 16. Also, when the present step is step 7, the present step is maintained as step 7 even if the user further depresses the up key 17. Information on the steps and luminance levels corresponding to the steps according to the AC characteristic curve and information on the steps and luminance levels corresponding to the steps according to the DC characteristic curve are respectively stored in a predetermined nonvolatile memory as AC brightness table information and DC brightness table information. Description will be made below of a line a with opposite-end arrows shown in FIG. 2.

During a time period when the notebook PC 10 uses power from the external alternating-current power supply (hereinafter referred to as “AC period” as occasion demands), the brightness of the LCD 15 is controlled on the basis of the AC brightness table. During a time period when the notebook PC 10 uses power from the internal battery (hereinafter referred to as “DC period” as occasion demands), the brightness of the LCD 15 is initially and ordinarily controlled on the basis of the DC brightness table and is controlled on the basis of the AC brightness table as occasion demands. During the DC period, the DC brightness table is used as a basis for control of the brightness of the LCD 15 for the purpose of saving battery power. When the user wishes to use the LCD 15 at a high brightness even during the DC period, the AC brightness table may be used as a basis for control of the brightness of the LCD 15 to enable use of the LCD to the user's wish.

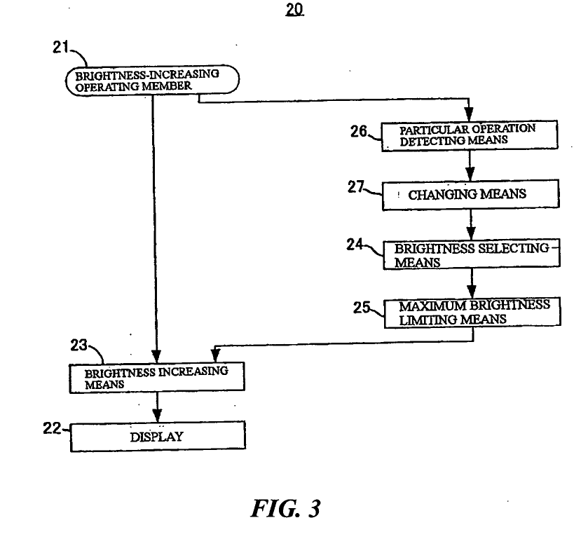

FIG. 3 is a functional block diagram of a display controller 20. A display device to which the display controller 20 is applied has a brightness increasing operating member 21 which is operated one time by the user in a predetermined manner when the user increases the brightness of a display 22 one step. The display controller 20 has brightness increasing means 23, brightness selecting means 24, maximum brightness limiting means 25, particular operation detecting means 26, and changing means 27. The brightness increasing means 23 increases the brightness of the display 22 on the basis of an operation on the brightness-increasing operating member 21. The brightness selecting means 24 selects as a selected brightness a first brightness or a second brightness lower than the first brightness. The maximum brightness limiting means 25 limits the brightness of the display 22 to the brightness selected by the brightness selection means 24. The particular operation detecting means 26 detects a particular operation in an operation in a predetermined manner on the brightness-increasing operating member 21 by regarding this particular operation as a user's request for increasing the maximum brightness. The changing means 27 makes the brightness selecting means 24 change the selected brightness from the second brightness to the first brightness if the particular operation is detected when the brightness selected by the brightness selecting means 24 is the second brightness.

The display controller 20 is provided, for example, in portable PCs including the notebook PC 10 (FIG. 1) and other portable information processing devices. The notebook PC 10 is an example of an appliance having the display controller 20 in an implemented form. The LCD 15 and the up key 17 of the notebook PC 10 correspond to the display 22 and the brightness-increasing operating member 21. The display 22 is not limited to the LCD. The first and second brightnesses correspond to the brightnesses related to step 0 in the AC characteristic curve and the DC characteristic curve shown in FIG. 2. The appliance equipped with the display controller 20 is capable of selectively using, for example, power from an external alternating-current power supply and power from an internal battery, as is the notebook PC 10. The second brightness is selected as the selected brightness during a time period when the appliance uses power from the internal battery. Change from the second brightness to the first brightness is made when a user who desires that the present maximum brightness should be changed makes a request to increase the maximum brightness.

When the user operates the brightness-increasing operating member 21 one time in the predetermined manner, the brightness of the display 22 is increased one step. When the user performs the particular operation in the operations in the predetermined manner, this operation is regarded as a user's request for increasing the maximum brightness and the brightness selected by the brightness selecting means 24 is changed from the second brightness to the first brightness by the changing means 27 if the brightness selected by the brightness selecting means 24 is the second brightness. Thus, the maximum brightness of the display 22 is changed from the second brightness to the first brightness. Although the power consumption is thereby increased, a display at the higher brightness can be provided for the user.

The operation in the predetermined manner is, for example, an operation in which the user depresses the brightness-increasing operating member 22 or an operation in which the user maintains the brightness-increasing operating member in the depressed state for a time equal to or longer than a predetermined time period. The particular operation in the operations in the predetermined manner is an operation in which the brightness-increasing operating member 22 is depressed at least a predetermined number of times per unit time.

The ordinary operation in which the user depresses the brightness-increasing operating member 21 to increase the brightness of the display one step is such that the number of times the operating member is depressed per unit time is small or the operating member is operated slowly. On the other hand, the particular operation corresponds to an operation in which the user frequently depresses the brightness-increasing operating member 21 in a short time. Therefore the particular operation can be detected by being discriminated from the ordinary depressing operation. In actuality, in a case where an ordinary user wishes to increase the brightness of the display 22 when the actual brightness of the display 22 reaches the second brightness while the maximum brightness of the display 22 is limited to the second brightness, he or she tends to operate the brightness-increasing operating member 21 by frequently depressing this operating member. Thus, the user's request for increasing the maximum brightness is detected through the particular operation on the brightness-increasing operating member 21 and the maximum brightness of the display 22 is changed to the first brightness higher than the second brightness.

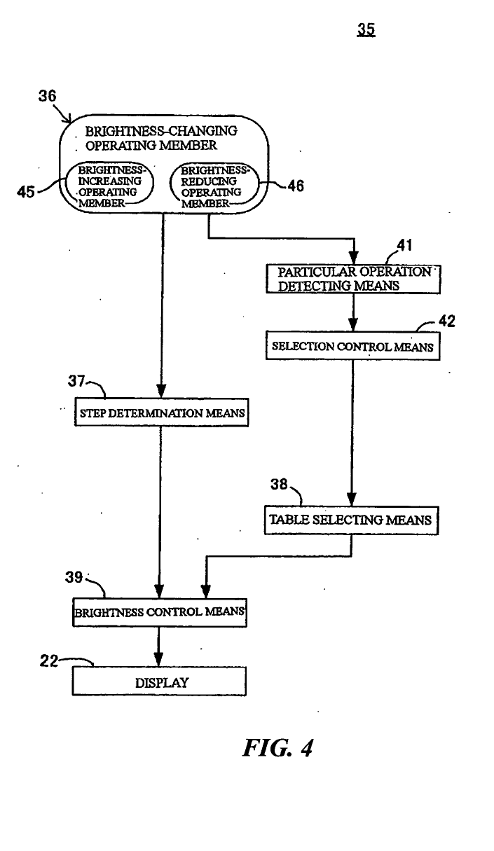

FIG. 4 is a functional block diagram of another display controller 35. A display device to which the display controller 35 is applied has a brightness-changing operating member 36 which is operated one time by the user in a predetermined manner when the user changes the brightness of display one step. The display controller 35 has step determination means 37, table selecting means 38, brightness control means 39, particular operation detecting means 41, and section control means 42. The step determination means 37 determines the present step on the basis of the operation on the brightness-changing operating member 36. The table selecting means 38 selects as a selected brightness table a first brightness table or a second brightness table. The brightness of the display is related to a finite number of steps in each brightness table in such a manner that the brightness increases in correspondence with the order from the lowest step to the highest step. The brightness related to the highest step in the first brightness table is higher than the brightness related to the highest step in the second brightness table. The brightness control means 39 controls the brightness of the display so that the actual brightness of the display is set to the brightness related to the step determined by the step determination means 37 in the brightness table selected by the table selecting means 38. The particular operation detecting means 41 detects a particular operation in operations on the brightness-changing operating member 36 in the predetermined manner when the brightness table selected by the table selecting means 38 is the second brightness table, by regarding the particular operation as a user's request for increasing the maximum brightness. The selection control means 42 makes the table selecting means 38 change the selected brightness table from the second brightness table to the first brightness on the basis of detection of the particular operation.

The display controller 35 is provided, for example, in portable PCs including the notebook PC 10 (FIG. 1) and other portable information processing devices. The notebook PC 10 is an example of an appliance having the display controller 35 in an implemented form. The LCD 15 of the notebook PC 10 corresponds to the display 22. The down key 16 and the up key 17 of the notebook PC 10 correspond to a brightness-increasing operating member 45 and a brightness-reducing operating member 46 in the brightness-changing operating member 36. The first and second brightness tables correspond to the AC brightness table and the DC brightness table described above in relation to the AC characteristic curve and the DC characteristic curve shown in FIG. 2. The appliance equipped with the display controller 35 is capable of selectively using, for example, power from an external alternating-current power supply and power from an internal battery, as is the notebook PC 10. The second brightness table is initially selected as the selected brightness table during a time period when the appliance uses power from the internal battery. Change from the second brightness table to the first brightness table is made when a user who desires that the present maximum brightness should be changed makes a request to increase the maximum brightness.

When the user operates the brightness-changing operating member 36 one time in the predetermined manner, the brightness of the display is changed one step. When the user performs the particular operation in the operations in the predetermined manner, this operation is regarded as a user's request for increasing the maximum brightness and detected by the particular operation detecting means 41, and the selection control means 42 makes the table selecting means 38 change the selected brightness table from the second brightness table to the first brightness table. Subsequently, the brightness control means 39 controls the brightness of the display so that the actual brightness of the display becomes equal to the brightness related to the step determined by the step determination means 37 in the first brightness table. Thus, the user can use the display controller 22 at the high brightness based on the first brightness table, although the power consumption is increased.

A further concrete example of the display controller 35 will be described. Components described below can be additionally provided in a freely selected combination in the display controller 35.

The brightness-changing operating member 36 includes the brightness-increasing operating member 45 specially provided for the operation performed by the user to increase the brightness of the display and operated by being depressed by the user. The step determination means 37 increases the present step one step each time the brightness-increasing operating member 45 is operated one time by the user until the present step reaches the highest step.

The particular operation of the brightness-changing operating member 36 is an operation in which the brightness-increasing operating member 45 is depressed at least a predetermined number of times per unit time. A typical user tends to operate (for example, depress) the brightness-changing operating member 36 comparatively slowly when increasing the brightness of the display 22 one step, and to frequently operate (for example, depress) the brightness-changing operating member 36 in a short time when he or she wants to use the display 22 at a sufficiently high brightness. In correspondence with this tendency, an event in which the brightness-increasing operating member 45 is operated at least the predetermined number of times per unit time is detected as the particular operation. This particular operation may be limited to the operation performed when the brightness of the display is equal to the brightness related to the highest step in the second brightness table.

In another example, the particular operation of the brightness-increasing operating member 45 is an operation in which the user depresses the brightness-increasing operating member 45 at least a predetermined number of times (e.g., three times) per unit time when the brightness of the display is equal to the brightness related to the highest step in the second brightness table, or an operation in which the user maintains the brightness-increasing operating member 45 in the depressed state at least for a predetermined time period (e.g., five seconds) when the brightness of the display is equal to the brightness related to the highest step in the second brightness table. When the second brightness table is selected and when the present step reaches the highest step, the brightness of the display 22 cannot exceed the maximum brightness in the second brightness table even if the user further operates the brightness-changing operating member 36. Even in a case where it is difficult to increase the brightness because of the selection of the second brightness table, an ordinary user who wishes to increase the brightness tends to repeat operating the brightness-changing operating member 36 or to continue depressing the brightness-changing operating member 36 while thinking that this operation is useless. In correspondence with this tendency, an event in which the user depresses the brightness-increasing operating member 45 the predetermined number of times (e.g., three times) or maintains the brightness-increasing operating member 45 in the depressed state at least for the predetermined time period when the brightness of the display is equal to the brightness related to the highest step in the second brightness table is detected as the particular operation.

When the selection control means 42 makes the table selecting means 38 change the selected brightness table from the second brightness table to the first brightness table, the step determination means 37 changes the present step to the step related to a brightness in the first brightness higher than the highest brightness in the second brightness table. This example of change is indicated by the line a in FIG. 2. A leftward sign and a rightward sign are respectively attached to the left end and the right end of this line a. The leftward sign indicates change from the second brightness table to the first brightness table, and the rightward sign indicates change from the first brightness table to the second brightness table. If the line a with one direction sign is called an arrow, each of the nocks of the rightward arrow and the leftward arrow indicates the step and brightness in the brightness table before the change, and each point indicates the step and brightness in the brightness table after the change. The change from the second brightness table to the first brightness table (leftward line a) is made from step 7, i.e., the highest step, in the second brightness table to step 6 in the first brightness table, because the brightness at step 6 in the first brightness table is the lowest of a plurality of brightnesses in the first brightness table higher than the brightness at step 7 in the second brightness table. The change destination in the case of change from the second brightness table to the first brightness table may be step 7 in the first brightness table.

The brightness-changing operating member 36 includes the brightness-reducing operating member 46 specially provided for the operation performed by the user to reduce the brightness of the display and operated by being depressed by the user. The step determination means 37 reduces the present step one step each time the brightness-reducing operating member 46 is operated one time by the user until the present step reaches the lowest step. When the brightness of the display is reduced to a level equal to or lower than the brightness at the highest step in the second brightness table by the depressing operation performed by the user on the brightness-reducing operating member 46 after the table selecting means 38 has changed the selected brightness table from the second brightness table to the first brightness table, the selection control means 42 makes the table selecting means 38 returns the selected brightness table from the first brightness table to the second brightness table. For example, change from the first brightness table to the second brightness table is made from step 6 in the first brightness table to step 7 in the second brightness table, as indicated by the rightward line a in FIG. 2, because the brightness at step 5 in the first brightness table is lower than the brightness at step 7 in the second brightness table and because the reason for use of the first brightness table is lost. The nock of the rightward line a arrow may be any of step 5 and the other lower steps in the first brightness table, and the nock of the point of the rightward line a arrow may be any of the steps in the second brightness table. However, in a case where the rightward line a slopes upward to the right as viewed in FIG. 2, the brightness of the display 22 increases when the user depresses the brightness-reducing operating member 46. In such a case, the user is liable to have a feeling of unnaturalness. For avoidance of this, a horizontal line or a line sloping downward to the right as viewed in FIG. 2 is preferred as the rightward line a.

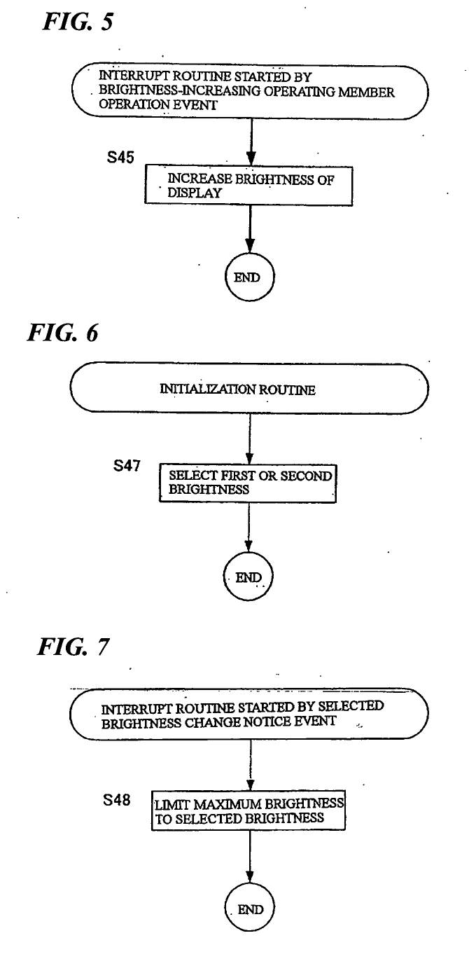

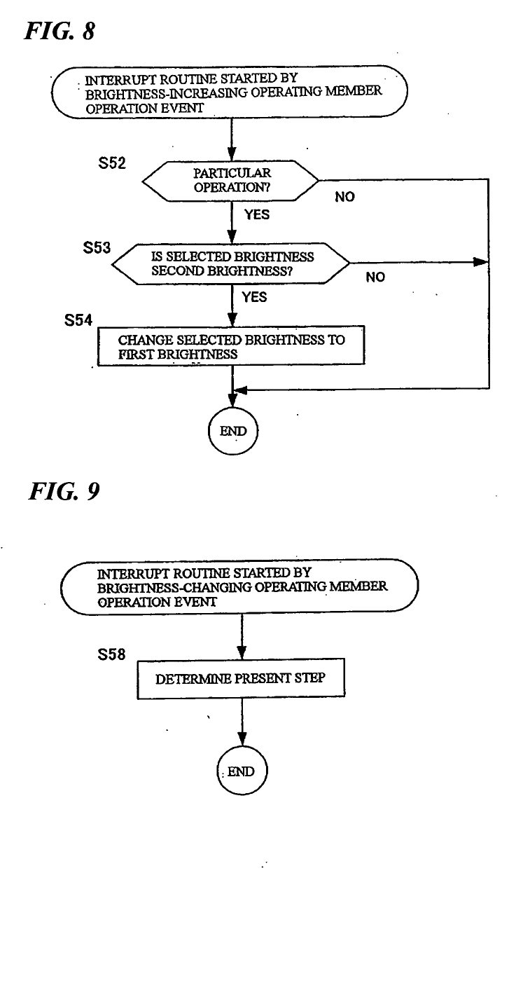

FIGS. 5 to 8 are flowcharts each showing partial processing according to a first display control method, which corresponds to the display controller 20 shown in FIG. 3. Each of the partial processings in FIGS. 5 to 8 is executed when an event occurs as an interrupt signal accompanying the operation of the brightness-increasing operating member 21. The partial processings in FIGS. 5 to 8 are executed in any priority order. The partial processing in FIG. 6 is executed as an initialization routine. This initialization routine is started when powering of the display controller 20 is started or when the power supply to the display controller 20 is changed between the external alternating-current power supply and the internal battery. The partial processing in FIG. 7 is executed when an event occurs as an interrupt signal accompanying a change of the selected brightness. The display control method includes steps having processing details described below.
The brightness of the display 22 is increased on the basis of the operation on the brightness-increasing operating member 21 (S45).
The first brightness or the second brightness lower than the first brightness is selected as the selected brightness (S47).
When the selected brightness is changed, the maximum brightness of the display 22 is limited on the basis of the changed selected brightness (S48).
The particular operation in the operations in the predetermined manner on the brightness-increasing operating member 21 is detected by being regarded as a user's request for increasing the maximum brightness of the display 22 (S52).
If the particular operation is detected when the selected brightness is the second brightness, the selected brightness is changed from the second brightness to the first brightness (S53, S54).

Each time step 54 is executed, a selected brightness change notice event occurs and the routine in FIG. 7 is started. The operation in the predetermined manner on the brightness-increasing operating member 21 is, for example, an operation in which the user depresses the brightness-increasing operating member 21. The particular operation in the operations in the predetermined manner detected in S52 is an operation in which the brightness-increasing operating member 21 is depressed at least a predetermined number of times per unit time when the brightness of the display is equal to the second brightness, or an operation in which the brightness-increasing operating member is maintained in the depressed state at least for a predetermined time period.

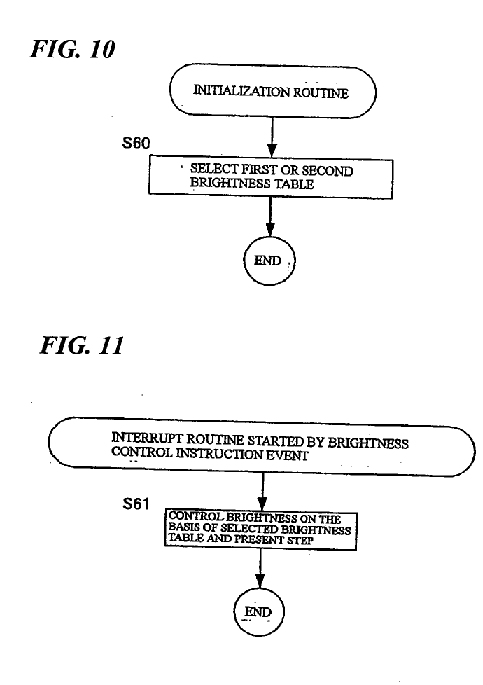

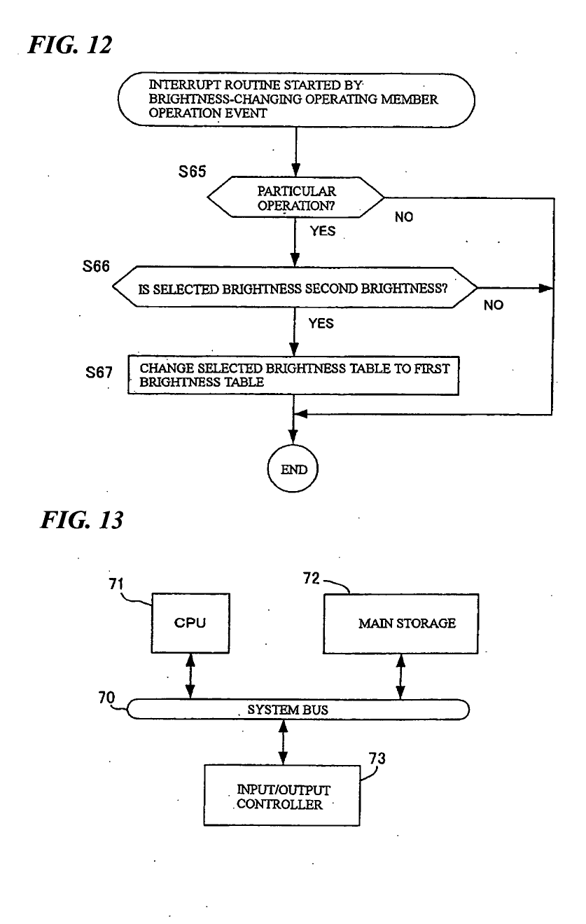

FIGS. 9 to 12 are flowcharts each showing partial processing according to a second display control method, which corresponds to the display controller 35 shown in FIG. 4. Each of the partial processings in FIGS. 9 to 12 is executed as an interrupt routine. Each of the partial processings in FIGS. 9 to 12 is executed when an event occurs as an interrupt signal accompanying the operation of the brightness-changing operating member 36. The partial processings in FIGS. 9 to 12 are executed in any priority order. The partial processing in FIG. 10 is executed as a routine for initialization of the selected brightness table when powering of the display controller 35 is started or when the power supply to the display controller 35 is changed between the external alternating-current power supply and the internal battery. A selected brightness setting event occurs when the display controller 35 is powered or when power supplied to the display controller 35 is changed, for example, when a switch is made between power from the external alternating current power supply and power from the battery. The partial processing in FIG. 11 is executed when a brightness control instruction event occurs as an interrupt signal. For example, the brightness control instruction event occurs when the brightness-changing operating member 36 is operated or when the selected brightness table is changed.

The second display control method includes steps described below.
The present step is determined on the basis of the operation on the brightness-changing operating member 36 (S58).
The brightness of the display is related to a finite number of steps in each of the first and second brightness tables in such a manner that the brightness increases in correspondence with the order from the lowest step to the highest step. The brightness related to the highest step in the first brightness table is higher than the brightness related to the highest step in the second brightness table. The first or second brightness table is selected as the selected brightness table (S60).
Control is executed accompanying a change of the selected brightness table or the present step so that the brightness of the display becomes equal to the brightness related to the present step in the selected brightness table (S61).
When the selected brightness table is equal to the second brightness table, the particular operation in the operations in the predetermined manner on the brightness-changing operating member 36 is detected by being regarded as a user's request for increasing the maximum brightness (S66, S65).
The selected brightness table is changed from the second brightness table to the first brightness table on the basis of the detection of the particular operation (S67).

The brightness control instruction event occurs accompanying the execution of step S67 to start the routine in FIG. 11.

Description will next be made of concrete forms of the second display control method described with reference to FIGS. 9 to 12. Any combination of the concrete forms described below can be added to the second display control method.

The brightness-changing operating member 36 includes the brightness-increasing operating member 45 specially provided for the operation performed by the user to increase the brightness of the display and operated by being depressed by the user. In S58 shown in FIG. 9, the present step is increased one step each time the brightness-increasing operating member 45 is operated one time by the user until the present step reaches the highest step.

Preferably, the particular operation on the brightness-changing operating member 36 is as described in (1) or (2) below.
(1) The particular operation is an operation in which the brightness-increasing operating member 45 is depressed at least a predetermined number of times per unit time. Further, the particular operation is limited to the operation performed when the brightness of the display is equal to the brightness related to the highest step in the second brightness table.
(2) The particular operation on the brightness-increasing operating member 45 is an operation in which the user depresses the brightness-increasing operating member 45 at least a predetermined number of times or maintains the brightness-increasing operating member 45 in the depressed state at least for a predetermined time period when the brightness of the display is equal to the brightness related to the highest step in the second brightness table.

In the operation in which the brightness-increasing operating member 45 is “depressed at least a predetermined number of times per unit time” as described in (1), the rate at which the brightness-increasing operating member 45 is operated must be higher that the ordinary operating rate. On the other hand, in the operation in which “the user depresses the brightness-increasing operating member 45 at least a predetermined number of times” as described in (2), the rate at which the brightness-increasing operating member 45 is operated may be the same as the ordinary operating rate. However, it is preferred that in the operation in which “the user depresses the brightness-increasing operating member 45 at least a predetermined number of times” in (2), processing for returning the count value to 0 should be performed if the time interval between the preceding depressing operation and the presenting depressing is equal to or longer than a predetermined time period, and a determination that the user has operated the brightness-increasing operating member 45 at least the predetermined number of times should be made only when the depressing count value becomes equal to the predetermined value.

When in S67 the selected brightness table is changed from the second brightness table to the first brightness table, the predetermined event occurs to start the routine shown in FIG. 9. In S58, the present step is changed to the step related to a brightness in the first brightness table higher than the highest brightness in the second brightness table. For example, this change corresponds to the leftward line a in FIG. 2.

The brightness-changing operating member 36 includes the brightness-reducing operating member 46 specially provided for the operation performed by the user to reduce the brightness of the display and operated by being depressed by the user. In S58, the present step is reduced one step each time the brightness-reducing operating member 46 is depressed one time by the user until the present step reaches the lowest step. S67 includes processing for returning, after the change of the selected brightness table from the second brightness table to the first brightness table, the selected brightness table from the first brightness table to the second brightness table when the brightness of the display is about to be made equal to or lower than the brightness set immediately before the change of the selected brightness table from the second brightness table to the first brightness table, by the user's depressing operation on the brightness-reducing operating member, or after the brightness of the display has become equal to or lower than the brightness set immediately before the change. For example, this returning processing corresponds to the rightward line a in FIG. 2.

The present invention can be implemented as a combination of pieces of hardware, a combination of pieces of software or a combination of pieces of hardware and software. Implementation in a computer system having a predetermined program can be mentioned as a typical example of implementation based on a combination of pieces of hardware and software. In this case, the predetermined program is loaded and executed in the computer system. The computer system is controlled by the program to execute processing in accordance with the present invention. This program is constituted by groups of instructions which can be expressed in a language, a code and a notation freely selected. Such groups of instructions enable the system to perform particular functions directly or after performing one or both of 1. conversion into another language, code and notation, and 2. copying to another medium. Needless to say, the present invention includes, in its scope, not only the program itself but also a medium on which the program is recorded. The program for executing the functions in accordance with the present invention can be stored on any computer-readable recording medium such as a flexible disk, an MO, a CD-ROM, a DVD, a hard disk unit, a ROM, an MRAM, or a RAM. The program may be downloaded from another computer system via a communication line to be stored on the recording medium or may be copied from another recording medium. Also, the program may be stored on a single recording medium or a plurality of recording mediums by being compressed or divided into a plurality of pieces.

FIG. 13 is a diagram showing the configuration of hardware for executing the program. The display control program for enabling a computer to function as each means of the above-described display controllers 20 and 35 is executed, for example, by using the hardware described with reference to FIG. 13, or the display control program for enabling a computer to execute each step in the above-described first and second display control methods is executed, for example, by using the hardware described with reference to FIG. 13. To a system bus 70, a CPU 71, a main storage 72 and an input/output controller 73 are connected. Each of the above-described means or steps can be executed as a coded program. The input/output controller 73 includes a hard disk interface or the like. Various programs executed by the CPU 71 are stored in a hard disk unit or the like. Each program is stored in the main storage 72 before being executed in the CPU 71. The CPU 71 reads out instruction lines in the main storage 72 one after another to execute the program.

In the drawings and specifications there has been set forth a preferred embodiment of the invention and, although specific terms are used, the description thus given uses terminology in a generic and descriptive sense only and not for purposes of limitation.

While generic claim terms are not limited to the specific embodiments disclosed, the following table illustrates how the generic claims terms find support in the terms used in the disclosed embodiments.

| Disclosure Terminology | Generic Claim Terms |
|---|---|
| brightness-increasing operating | brightness-increase operator |
| member | |
| brightness increasing means | brightness increaser |
| brightness selecting means | brightness selector |
| maximum brightness limiting means | maximum brightness limiter |
| particular operation detecting means | particular operation detector |
| changing means | changer |
| brightness-changing operating member | brightness-change operator |
| step determination means | step determiner |
| table selecting means | table selector |
| brightness control means | brightness controller |
| particular operation detecting means | particular operation detector |
| selection control means | selection controller |

1. A display controller comprising:
a brightness-increase operator which is operated one step at a time in a predetermined manner by a user in order to increase the brightness of a display;
a brightness increaser which increases the brightness of the display on the basis of an operation on the brightness-increase operator;
a brightness selector which selects as a selected brightness a first brightness or a second brightness lower than the first brightness;
a maximum brightness limiter which limits the maximum brightness of the display to the brightness selected by said brightness selector;
a particular operation detector which detects a particular operation in operations on the brightness-increase operator in the predetermined manner by regarding the particular operation as a user's request for increasing the maximum brightness; and
a changer which makes said brightness selector change the selected brightness from the second brightness to the first brightness on condition that the a particular operation is detected when the brightness selected by said brightness selector is the second brightness.

2. The display controller according to claim 1, wherein the operations in the predetermined manner are operations in which the user depresses the brightness-increase operator, and the particular operation in the operations in the predetermined manner is an operation in which the number of times the brightness-increase operator is depressed is equal to or larger than a predetermined number of times, or an operation in which the brightness-increase operator is maintained in a depressed state at least for a predetermined time period.

3. A display controller comprising:
a brightness-change operator which is operated one step at a time in a predetermined manner by a user in order to change the brightness of the display;
a step determiner which determines the present step on the basis of the operation on the brightness-change operator;
a table selector which selects as a selected brightness table a first brightness table or a second brightness table, the brightness of the display being related to a finite number of steps in each brightness table in such a manner that the brightness increases in correspondence with the order from the lowest step to the highest step, the brightness related to the highest step in the first brightness table being higher than the brightness related to the highest step in the second brightness table;
a brightness controller which controls the brightness of the display so that the actual brightness of the display is set to the brightness related to the step determined by said step determiner in the brightness table selected by said table selector;
a particular operation detector which detects a particular operation in operations on the brightness-change operator in the predetermined manner when the brightness table selected by said table selector is the second brightness table, by regarding the particular operation as a user's request for increasing the maximum brightness; and
a selection controller which makes said table selector change the selected brightness table from the second brightness table to the first brightness table on the basis of detection of the particular operation.

4. The display controller according to claim 3, wherein the brightness-change operator includes a brightness-increase operator specially provided for an operation performed by the user to increase the brightness of the display and operated by being depressed by the user; said step determiner increases the present step one step each time the brightness-increase operator is operated one time by the user until the present step reaches the highest step; and the particular operation on the brightness-change operator is an operation in which the brightness-increase operator is depressed at least a predetermined number of times per unit time.

5. The display controller according to claim 4, wherein the particular operation on the brightness-increase operator is an operation performed when the brightness of the display is equal to the brightness related to the highest step in the second brightness table.

6. The display controller according to claim 3, wherein the brightness-change operator includes a brightness-increase operator specially provided for the operation performed by the user to increase the brightness of the display and operated by being depressed by the user; said step determiner increases the present step one step each time the brightness-increase operator is operated one time by the user until the present step reaches the highest step; and the particular operation on the brightness-change operator is an operation in which the brightness-increase operator is depressed at least a predetermined number of times or is maintained in the depressed state at least for a predetermined time period when the brightness of the display is equal to the brightness related to the highest step in the second brightness table.

7. The display controller according to claim 3, wherein on condition that said selection controller makes said table selector change the selected brightness table from the second brightness table to the first brightness table, said step determiner changes the present step to one of the steps in the first brightness table higher than the highest brightness in the second brightness table.

8. The display controller according to claim 3, wherein the brightness-change operator includes a brightness-decrease operator specially provided for the operation performed by the user to reduce the brightness of the display and operated by being depressed by the user; said step determiner reduces the present step one step each time the brightness-decrease operator is operated one time by the user until the present step reaches the lowest step; and, after said table selector has changed the selected brightness table from the second brightness table to the first brightness table, said selection controller makes said table selector return the selected brightness table from the first brightness table to the second brightness table on condition that the brightness of the display is reduced to a level equal to or lower than the brightness corresponding to the highest step in the second brightness table by the user's depressing operation on the brightness-decrease operator.

9. The display controller according to claim 3, wherein said selection controller makes said table selector select the first brightness table as the selected table on condition that supply of power from an external alternating-current power supply to an appliance equipped with the display controller is started, and said selection controller makes said table selector select the second brightness table as the selected table on condition that supply of power from an internal battery is started.

10. A method comprising:
increasing the brightness of a display having a brightness-increasing operating member which is operated one step at a time in a predetermined manner by a user in order to increase the brightness of the display, the brightness increase being performed on the basis of an operation on the brightness-increasing operating member;
selecting as a selected brightness a first brightness or a second brightness lower than the first brightness;
limiting, if the selected brightness is changed, the maximum brightness of the display on the basis of the changed selected brightness;
detecting a particular operation in operations on the brightness-increasing operating member in the predetermined manner by regarding the particular operation as a user's request for increasing the maximum brightness; and
changing the selected brightness from the second brightness to the first brightness if the particular operation is detected when the selected brightness is the second brightness.

11. The display control method according to claim 10, wherein the operations in the predetermined manner are operations in which the user depresses the brightness-increasing operating member, and the particular operation in the operations in the predetermined manner is an operation in which the number of times the brightness-increasing operating member is depressed is equal to or larger than a predetermined number of times, or an operation in which the brightness-increasing operating member is maintained in a depressed state at least for a predetermined time period.

12. A display control method for a display device having a brightness-changing operating member which is operated one time in a predetermined manner by a user in order to change the brightness of the display one step, said method comprising:
a step-determination act of determining the present step on the basis of the operation on the brightness-increasing operating member;
a selecting act of selecting as selected brightness table a first brightness table or a second brightness table, the brightness of the display being related to a finite number of steps in each brightness table in such a manner that the brightness increases in correspondence with the order from the lowest step to the highest step, the brightness related to the highest step in the first brightness table being higher than the brightness related to the highest step in the second brightness table;
a brightness control act of executing, on condition that the selected brightness table or the present step is changed, such control that the actual brightness of the display is set to the brightness related to the present step in the selected brightness table;
a particular operation detecting act of detecting a particular operation in operations on the brightness-changing operating member in the predetermined manner when the selected brightness table is the second brightness table, by regarding the particular operation as a user's request for increasing the maximum brightness; and
a selection control act of changing the selected brightness table from the second brightness table to the first brightness table on the basis of detection of the particular operation.

13. The display control method according to claim 12, wherein the brightness-changing operating member includes a brightness-increasing operating member specially provided for the operation performed by the user to increase the brightness of the display and operated by being depressed by the user; in said step determination act the present step is increased one step each time the brightness-increasing operating member is operated one time by the user until the present step reaches the highest step; and the particular operation on the brightness-changing operating member is an operation in which the brightness-increasing operating member is depressed at least a predetermined number of times per unit time.

14. The display control method according to claim 13, wherein the particular operation on the brightness-increasing operating member is an operation performed when the brightness of the display is equal to the brightness related to the highest step in the second brightness table.

15. The display control method according to claim 12, wherein the brightness-changing operating member includes a brightness-increasing operating member specially provided for the operation performed by the user to increase the brightness of the display and operated by being depressed by the user; in said step determination act is increased one step each time the brightness-increasing operating member is operated one time by the user until the present step reaches the highest step; and the particular operation on the brightness-changing operating member is an operation in which the brightness-increasing operating member is depressed at least a predetermined number of times or is maintained in the depressed state at least for a predetermined time period when the brightness of the display is equal to the brightness related to the highest step in the second brightness table.

16. The display control method according to claim 12, wherein the brightness-changing operating member includes a brightness-reducing operating member specially provided for the operation performed by the user to reduce the brightness of the display and operated by being depressed by the user; in said step-determination act the present step is reduced one step each time the brightness-reducing operating member is operated one time by the user until the present step reaches the lowest step; and said selection control act includes processing for returning, after the change of the selected brightness table from the second brightness table to the first brightness table, the selected brightness table from the first brightness table to the second brightness table on condition that the brightness of the display is about to be made equal to or lower than the brightness set immediately before the change of the selected brightness table from the second brightness table to the first brightness table, by the user's depressing operation on the brightness-reducing operating member, or the brightness of the display has become equal to or lower than the brightness set immediately before the change.

17. A product comprising:
a computer usable medium having computer readable program code stored therein for controlling a display device having a brightness-increasing operating member which is operated one time in a predetermined manner by a user in order to increase the brightness of the display one step, the computer readable program code in said product being effective to:
increase the brightness of the display on the basis of an operation on the brightness-increasing operating member;
select as a selected brightness a first brightness or a second brightness lower than the first brightness;
limit the maximum brightness of the display to the brightness selected by the brightness selection;
detect a particular operation in operations on the brightness-increasing operating member in the predetermined manner by regarding the particular operation as a user's request for increasing the maximum brightness; and
change the selected brightness from the second brightness to the first brightness if the particular operation is detected when the brightness selected by the brightness selection is the second brightness.

18. A product comprising:
a computer usable medium having computer readable program code stored therein for controlling a display device having a brightness-changing operating member which is operated one step at a time in a predetermined manner by a user in order to change the brightness of the display, the computer readable program code in said product being effective to:
determine the present step on the basis of the operation on the brightness-changing operating member;
select as a selected brightness table a first brightness table or a second brightness table, the brightness of the display being related to a finite number of steps in each brightness table in such a manner that the brightness increases in correspondence with the order from the lowest step to the highest step, the brightness related to the highest step in the first brightness table being higher than the brightness related to the highest step in the second brightness table;
control the brightness of the display so that the actual brightness of the display is set to the brightness related to the step determined by the determination in the brightness table selected by the table selection;
detecting a particular operation in operations on the brightness-changing operating member in the predetermined manner when the brightness table selected by the table selection is the second brightness table, by regarding the particular operation as a user's request for increasing the maximum brightness; and
changing the selected brightness table from the second brightness table to the first brightness table on the basis of detection of the particular operation.
